(19) United States
(12) Patent Application Publication
(10) Pub. No.: US 2025/0355678 A1
(43) Pub. Date: Nov. 20, 2025

(54) MANAGING TROUBLESHOOTING MODES OF COMPUTING DEVICES

(71) Applicant: Aivres Systems Inc., San Jose, CA (US)

(72) Inventor: Yucheng LIN, New Taipei City (TW)

(21) Appl. No.: 19/287,479

(22) Filed: Jul. 31, 2025

(51) Int. Cl. G06F 9/445; G05B 15/02

(52) U.S. Cl. CPC G06F 9/44505; G05B 15/02

(57) ABSTRACT

Methods, devices, and systems for managing troubleshooting modes of a computing device are provided. In one aspect, a computing device includes: a housing; a cooler; a temperature sensor inside the housing; a door moveably mounted on a side panel of the housing; and a controller. The door is configured to transmit a request to enter a troubleshooting mode for the computing device in response to the door being opened. The controller is coupled to the door, the temperature sensor, and the cooler. The controller is configured to: receive, from the door, the request to enter the troubleshooting mode; and in response to the request: obtain a first temperature from the temperature sensor; and set the first temperature as a target temperature for the troubleshooting mode.

### TECHNICAL FIELD

The present disclosure is related to a troubleshooting operation for a computing device.

### BACKGROUND

Computing devices, such as servers, are widely used in a variety of fields. In areas such as artificial intelligence (AI) and big data, the need for computing is growing rapidly. To improve flexibility and computational efficiencies, some computing devices are configured to include different external devices within the same server chassis, making the computing devices suitable for a variety of applications. When a computing device encounters an issue, different troubleshooting methods can be used, e.g., remote troubleshooting and local (on-site) troubleshooting. Remote troubleshooting can involve diagnosing server issues through network access, while local troubleshooting may need physical access to the server, including inspecting hardware connections, checking physical indicators (e.g., light emitting diodes (LEDs)), or connecting diagnosis tools directly.

### SUMMARY

The present disclosure describes systems and techniques for a computing device having a door on a side panel that allows insertion of a troubleshooting cable into the interior space of the computing device, and operating methods of the computing device for maintaining an internal temperature at a target level during a troubleshooting process.

When an issue (e.g., an operational failure or error) occurs in the computing device, troubleshooting operations may be conducted. In some situations, a top cover of a housing of the computing device may be opened to allow diagnostic tools (e.g., a troubleshooting cable) to be connected to electronic devices (e.g., processors) that are positioned inside the housing. Opening the top cover may impact an airflow inside the housing, thereby impacting the cooling efficiency. As a result, opening the top cover may cause rapid changes in the temperature surrounding the electronic devices. In addition, opening the top cover may require removing the computing device from a rack (e.g., a server rack where the computing device is positioned), further disrupting the original environmental conditions. These changes may impact the diagnosis accuracy, particularly if the root cause involves factors like the power supply or excessive heat inside the housing. Therefore, improving the housing design to enable local debugging without opening the top cover or removing the computing device from the server, as well as operating methods for preserving the original state of the computing device, may be desired to allow for effective root cause analysis.

In an implementation, a computing device includes: a housing; a cooler; a temperature sensor inside the housing; a door moveably mounted on a side panel of the housing; and a controller. The door, when opened, is configured to transmit a request to enter a troubleshooting mode for the computing device. The controller is coupled to the door, the temperature sensor, and the cooler. The controller is configured to: receive, from the door, the request to enter the troubleshooting mode; in response to the request: obtain a first temperature from the temperature sensor; and set the first temperature as a target temperature for the troubleshooting mode.

The subject matter described in this specification can be implemented to realize one or more of the following benefits, effect and/or advantages. For example, the techniques described in the present disclosure increase troubleshooting accuracy by maintaining original environmental conditions of the computing device that were present at the time an issue occurred. In some implementations, the computing device includes a door movably mounted to a front panel of the computing device. When the door is opened, the troubleshooting cable can be inserted into the interior space of the computing device without a need to remove the top cover. In some implementations, the door can be on a same panel as an air vent or on a side panel that is away from a high temperature region (e.g., away from processors), thereby reducing overall impact on the internal airflow or temperature of the computing device. In addition, as the opened door can provide an easy access to the internal electronic devices of the computing device, there may be no need to remove the computing device from the rack, thereby further preserving the original environment for troubleshooting. Therefore, the diagnosis accuracy may be improved.

Further, in some implementations, the computing device is configured to maintain a stable temperature during the troubleshooting process using a controller, a temperature sensor and a cooler (e.g., a fan). The door can send a request to the controller once opened. The request can indicate to the controller to enter a troubleshooting mode. In the troubleshooting mode, the controller can periodically obtain real-time temperature readings from the temperature sensor and control the cooler to adjust the temperature to maintain the temperature at the target level during the troubleshooting process. The target temperature may correspond to the temperature present when the issue occurred or when the door was opened. By preserving the original temperature for troubleshooting, the diagnosis accuracy may further be improved.

The described subject matter can be implemented using a computer-implemented method; a non-transitory, computer-readable medium storing computer-readable instructions to perform the computer-implemented method; and a computer-implemented system comprising one or more computer memory devices interoperably coupled with one or more computers and having tangible, non-transitory, machine-readable media storing instructions that, when executed by the one or more computers, perform the computer-implemented method/the computer-readable instructions stored on the non-transitory, computer-readable medium.

The details of one or more implementations of the subject matter of this specification are set forth in the Detailed Description, the Claims, and the accompanying drawings. Other features, aspects, and advantages of the subject matter will become apparent to those of ordinary skill in the art from the Detailed Description, the Claims, and the accompanying drawings.

### DESCRIPTION OF DRAWINGS

FIG. 1 illustrates a schematic diagram of an example of a computing device.

FIG. 2 illustrates an isometric view of a housing of the computing device of FIG. 1.

FIG. 3A illustrates a plan view of the computing device of FIG. 1 with a door in a closed position and an example of temperature distribution.

FIG. 3B illustrates a plan view of the computing device of FIG. 1 with the door in an open position.

FIG. 4 illustrates an example of a front panel of the computing device of FIG. 1.

FIG. 5 illustrates a flow chart of an example of a method of operating a computing device.

FIG. 6 is a block diagram illustrating an example of a computer-implemented system.

Like reference numbers and designations in the various drawings indicate like elements. It is to be understood that the various exemplary implementations shown in the figures are merely illustrative representations and are not necessarily drawn to scale.

### DETAILED DESCRIPTION

The present disclosure describes a computing device with an easy access to internal electronic devices for troubleshooting, and operating methods of the computing device for preserving an original temperature level during the troubleshooting process to improve diagnosis accuracy. The computing device can support general computation tasks, and/or high-performance computing (HPC) applications. The computing device can include a housing with a front panel, and the front panel can include a door that is movably mounted to the remaining portion of the front panel. The computing device can further include a temperature sensor configured to sense a temperature inside the housing, a cooler configured to decrease the temperature, and a controller configured to control the temperature sensor and the cooler to keep a stable temperature. When an issue (e.g., an operational failure or an error) occurs in the computing device, a local (e.g., on-site) troubleshooting may be performed by maintenance personnel. Without the need to remove a top cover of the housing or taking the computing device out of a server rack, the maintenance personnel may open the door in the front panel and insert a troubleshooting cable into the housing to connect with an internal electronic device (e.g., a processor). The troubleshooting cable can establish a communication link with the electronic device for fault isolation. Further, when the door is opened, the door can transmit a signal to the controller. The controller can enter a troubleshooting mode in response to the signal. In the troubleshooting mode, the controller can periodically obtain real-time temperature readings from the temperature sensor and control the cooler to adjust the temperature to maintain the temperature at a target level during the troubleshooting process. The target temperature may correspond to the temperature present when the issue occurred or when the door was opened. By preserving the original environment conditions (e.g., temperature and position of the computing device) for troubleshooting, the diagnosis accuracy may be improved.

The following detailed description describes systems and techniques for the computing device, and is presented to enable any person skilled in the art to make and use the disclosed subject matter in the context of one or more particular implementations. Various modifications, alterations, and permutations of the disclosed implementations can be made and will be readily apparent to those of ordinary skill in the art, and the general principles defined can be applied to other implementations and applications, without departing from the scope of the present disclosure. In some instances, one or more technical details that are unnecessary to obtain an understanding of the described subject matter and that are within the skill of one of ordinary skill in the art may be omitted so as to not obscure one or more described implementations. The present disclosure is not intended to be limited to the described or illustrated implementations, but to be accorded the widest scope consistent with the described principles and features.

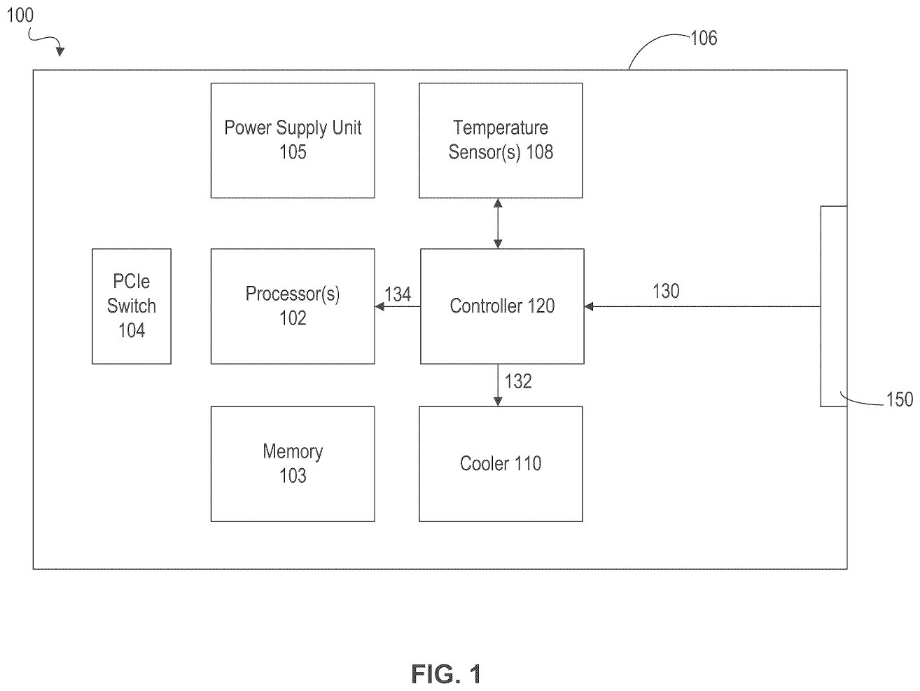

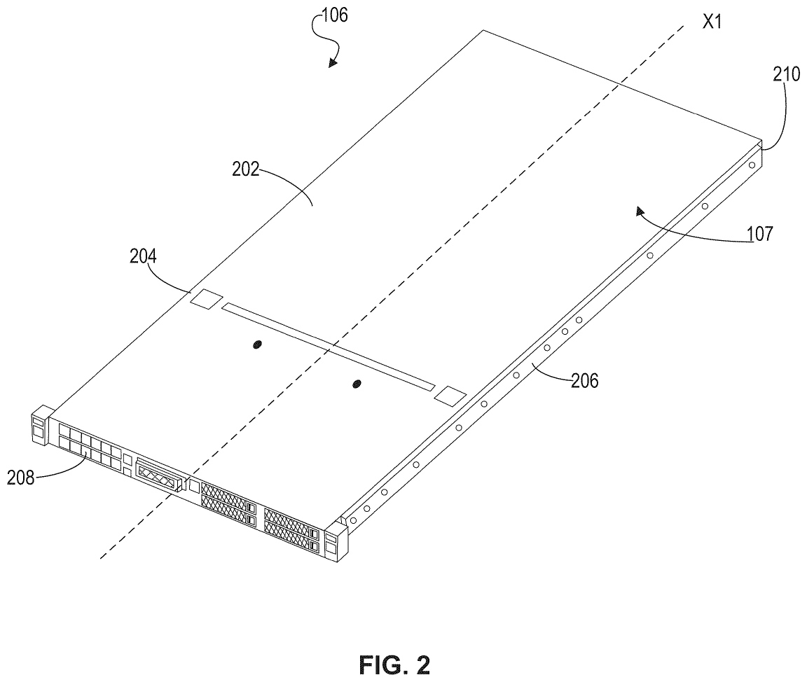

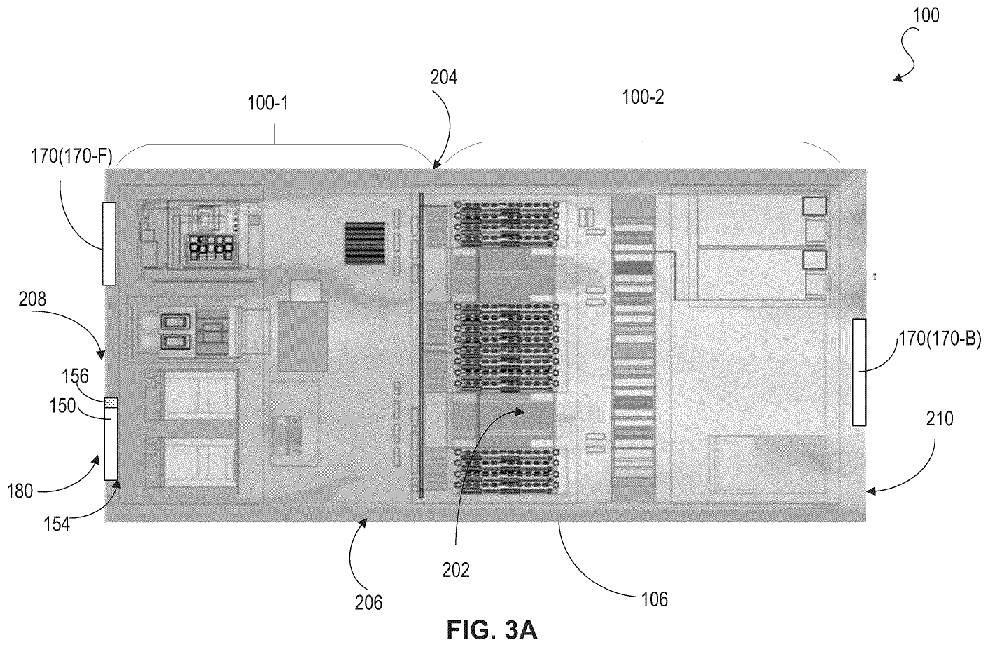

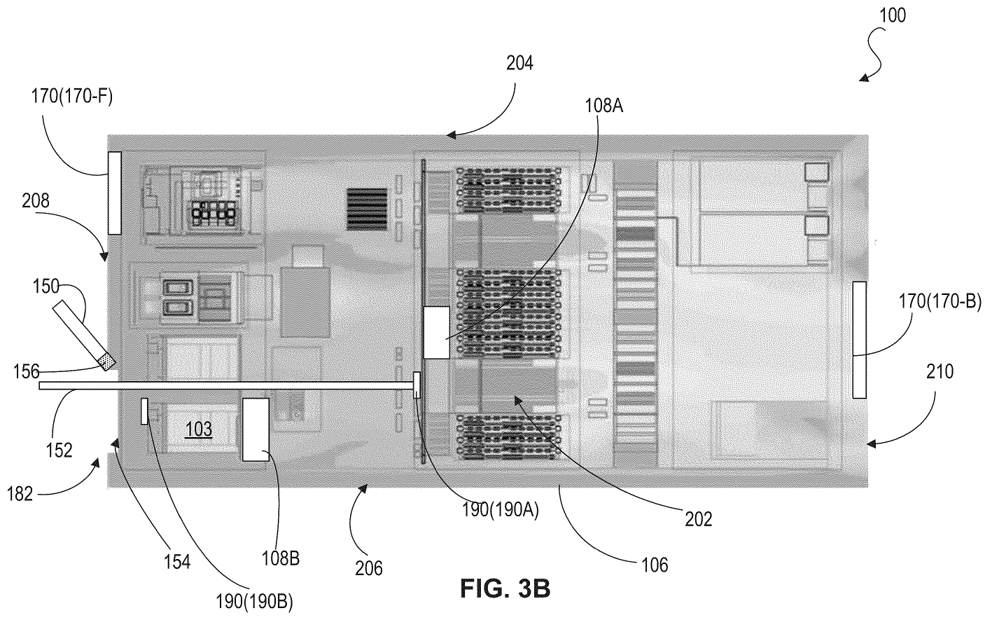

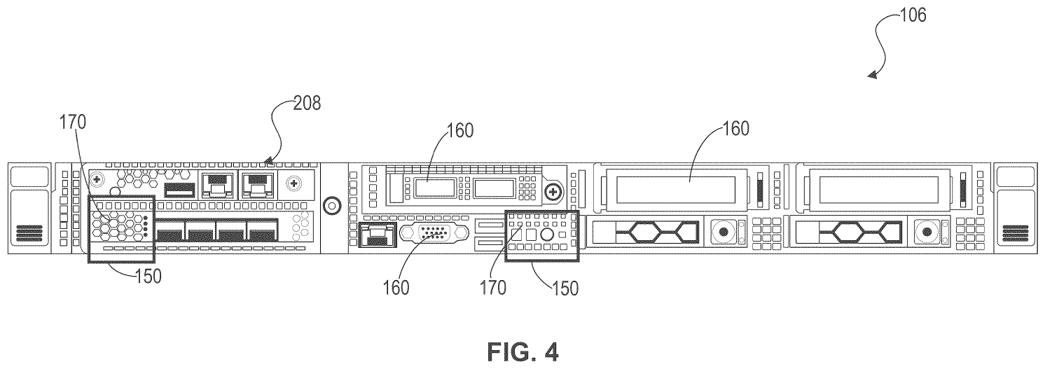

FIG. 1 illustrates a schematic diagram of an example of a computing device 100. FIG. 2 illustrates an isometric view of a housing 106 of the computing device 100. FIG. 3A illustrates a plan view of the computing device 100 of FIG. 1 with a door 150 in a closed position and an example of temperature distribution. FIG. 3B illustrates a plan view of the computing device 100 of FIG. 1 with the door 150 in an open position. Lighter color in FIGS. 3A and 3B can present a higher temperature. FIG. 4 illustrates an example of a front panel 208 of the computing device 100. For ease of description, reference will be made to FIGS. 1-4 when describing the structure of the computing device 100.

As illustrated in FIG. 1, the computing device 100 can be a computing system (such as, a server or a computer). In some implementations, the computing device 100 can be configured to support general computation tasks, high-performance computing (HPC) applications, deep learning applications, artificial intelligence (AI), and/or high storage capacity in flexible configurations. The computing device 100 includes one or more electronic devices. The one or more electronic devices include one or more processors 102. The one or more processors 102 can include, e.g., one or more central processing units (CPUs), one or more graphics processing units (GPUs), one or more data processing units (DPUs), one or more Application Specific Integrated Circuits (ASICs), one or more Field Programmable Gate Arrays (FPGAs), one or more multi-core processors, one or more microprocessors, one or more quantum processors, or a combination thereof. The computing device 100 can additionally include a power supply unit 105 (e.g., a multi-phase voltage regulator) configured to supply power to at least the processors 102.

The computing device 100 can include one or more memories 103, such as volatile memory (e.g., RAM) for temporary data storage and non-volatile memory (e.g., flash storage, NAND, ferroelectric memory devices, magneto-resistive memory devices, or hard drives) for long term data retention. The memory 103 can store various types of information, e.g., system configurations, fault status logs, user settings, and application data.

The computing device 100 can include a Peripheral Component Interconnect Express (PCIe) switch 104 to connect external devices to processors. In some examples, the PCIe switch 104 can act as a hub, enabling communication between multiple PCIe devices (like graphics processing unit (GPUs), storage devices, and network cards) and the processors 102. The PCIe switch 104 can manage data transfer and reduce latency by managing the distribution of PCIe lanes.

The computing device 100 can include a controller 120. In some implementations, the controller 120 is a baseboard management controller (BMC). The BMC can include a microcontroller that provides out-of-band management of the computing device 100. In some implementations, the controller 120 can provide administrators with remote access and control over hardware, for example, even when the computing device 100 is powered off or unresponsive. Typically, the controller 120 can be accessible by the administrators via a dedicated Ethernet (or LAN) port or a shared network interface, thereby allowing secure remote connections.

In some implementations, the controller 120 is configured to monitor various system health parameters, e.g., temperature, fan speeds, power supply voltages, CPU usage, or memory health. The controller 120 can be coupled to one or more sensors. The one or more sensors can include, without limitation to, (i) a temperature sensor 108 configured to monitor the temperature; (ii) a voltage sensor configured to monitor power supply levels; (iii) a fan sensor configured to monitor fan speed and airflow; (iv) a memory fault sensor configured to detect faults in memory devices or memory controllers; and/or (v) a power sensor configured to monitor the health of the power supply (e.g., whether the power levels are within the required range). In some implementations, the temperature sensor 108 is within or adjacent to an electronic device of the computing device 100, e.g., a CPU, a GPU, a smart network interface card (NIC), a platform controller hub (PCH), or a voltage regulator (VR). In some implementations, the controller 120 is coupled to the one or more processors 102. The controller 120 can be configured to communicate with the processors 102 through the inter-integrated circuit (I2C) communication protocol.

The computing device can further include a cooler 110 to decrease a temperature surrounding the electronic devices to reduce the risk of overheating. In some implementations, the cooler 110 includes a fan. In some implementations, the cooler 110 includes a liquid cooler. The liquid cooler can include a cold plate with channels through which a liquid coolant flows. The cold plate of the cooler 110 can be placed at or near the processors 102. In some implementations, the computing device 100 includes a housing 106. The electronic devices described above can be positioned inside the housing 106.

Referring to FIG. 2, in some implementations, the housing 106 includes an elongated box 107 having a longitudinal axis X1. The elongated box 107 can have four long panels extending along the longitudinal axis X1. The four long panels can include a top cover 202, a bottom cover, and left and right panels 204, 206 joining the top cover 202 and the bottom cover. The elongated box 107 can further include a front panel 208 and a back panel 210 at respective opposite ends of the four long panels. The top cover 202 can be an upper surface of the housing 106 when the computing device 100 is in its standard orientation, and the bottom cover can be the lower surface of the housing 106 that is opposed to the top cover 202. The front panel 208 may be the side surface that faces a user, while the back panel may be the side surface that is opposed to the front panel 208. In some examples, the front panel 208 can include interface like power buttons, LED indicators, and one or more input/output (I/O) ports (e.g., I/O ports 160 of FIG. 4). The I/O ports can include universal serial bus (USB) ports, small form-factor pluggable plus (SFP+) ports, hard disk drive (HDD) ports, and/or registered jack 45 (RJ45) ports, while the back panel can include host network ports, power supply connections, or cooling fan exhausts. The left panel 204, the right panel 206, the front panel 208, and the back panel 210 can be individually or collectively reference to as side panels in the present disclosure. It is to be noted that FIG. 2 is for illustration purposes only and not intended to be construed in a limiting sense. The housing 106 can be any shape (e.g., a cube, or any other regular or irregular shape) compatible with electronic devices therein.

The housing 106 can be configured to provide structural strength, thermal conductivity and electromagnetic interference (EMI) shielding. In some implementations, the housing 106 includes a conductive material. For example, the housing 106 can be made of steel, aluminum, copper, nickel, nickel alloy, or any combination thereof. In some implementations, the housing 106 includes a plastic material.

Referring to FIG. 3A, during operation, multiple electronic devices (e.g., processors 102, power supply unit 105) in the computing device 100 can generate heat. As the power demand increases (e.g., high CPU/GPU workloads), the heat output may rise significantly, sometimes exceeding 100° C. in extreme conditions. Excessive heat may be trapped inside the housing 106 and cause the failure of the computing device 100. To reduce the heat inside the housing 106, in some implementations, the computing device 100 includes an air vent 170 on the side panels, e.g., the front panel 208, and/or the back panel 210. The air vents 170 can be an opening or an array of openings that extend through a corresponding panel of the housing 106, allowing air to flow in or out. For example, the front air vent 170-F can be an air intake port, allowing cooler 110 ambient air to enter to the housing 106. The ambient air can flow inside the housing 106 and exit the housing 106 through the back air vents 170-B. Therefore, an airflow can form between the front air vent 170-F and the back air vent 170-B to reduce the temperature inside the housing 106.

As noted above, when an issue (e.g., an operational failure or error) occurs in the computing device, troubleshooting operations may be conducted. In some situations, a top cover of a housing of the computing device may be opened to allow diagnostic tools to be connected to electronic devices (e.g., processors 102) that are positioned inside the housing. Opening the top cover may impact an airflow inside the housing, thereby impacting the cooling efficiency. As a result, opening the top cover may cause rapid changes in the temperature surrounding the electronic devices. In addition, opening the top cover may require removing the computing device from a rack (e.g., a server rack where the computing device is positioned), further disrupting the original environmental conditions. These changes may impact the diagnosis accuracy, particularly if the root cause involves factors like the power supply or excessive heat inside the housing. Therefore, improving the housing design to enable local debugging without opening the top cover or removing the computing device from the server, as well as operating methods for preserving the original state of the computing device, may be desired to allow for effective root cause analysis.

In some implementations, the computing device 100 includes a door 150. In some implementations, as illustrated in FIGS. 3A and 3B, the door 150 is configured to cover an opening 154 on the side panel of the housing 106 when (e.g., in response to) closed. When the door 150 is opened, the opening 154 allows a troubleshooting cable 152 to be inserted into the housing 106. The door 150 can be located at an end of housing 106 and in particular, a front panel 208 of housing 106. However, door 150 can be located on any side panel of the housing 106, including the back panel 210, the left panel 204, and the right panel 206. In some implementations, the door 150 is located on a side panel that is adjacent to a low temperature region in the computing device 100. For example, as illustrated in FIG. 3A, the computing device 100 has a first region 100-1 and a second region 100-2. The second region 100-2 can include processors 102. During operation, the second region 100-2 can have a higher temperature compared to the first region 100-1. Therefore, the door 150 can be located at the front panel 208 that is adjacent to the low temperature region (e.g., the first temperature region 100-1).

In some implementations, the door 150 can be made of a material similar to housing 106 including, but not limited to metal and/or steel. In some implementations, the door 150 has a width between 5 mm to 15 mm, and a height between 2 mm to 15 mm. The door 150 can have a thickness that is equal to a thickness of the housing 106.

In some implementations, door 150 is part of a side panel. An area of the door 150 can be smaller than an area of the corresponding side panel. In some implementations, the door 150 is movably mounted on a remaining portion of the side panel of the housing 106. The door 150 can move between a closed and/or locked position 180 (e.g., as illustrated in FIG. 3A), and an open and/or unlocked position 182 (e.g., as illustrated in FIG. 3B). In the closed position 180, the door 150 can cover the opening 154. In the open position 182, the door 150 can uncover the opening 154. In some implementations, door 150 includes at least one mechanism (e.g., hinges) that is configured to moveably mount door 150 to the housing 106, as well as to enable door 150 to move between the open and closed positions. In the open position 182, the hinge side of the door can still be attached to the housing 106. Door 150 can open outward or inward.

In some implementations, door 150 can include locking and/or latching mechanism, and the like (including, but not limited to, snap-fit, springs, latches, locks, and the like) for locking and/or latching door 150 into the closed position 180.

In some implementations, the housing 106 includes more than one door 150. For example, the housing 106 can include a first door at a front panel 208, and a second door at a back panel 210. In another example, as illustrated in FIG. 4, the housing 106 can include two doors 150 at the front panel 208. In some implementations, multiple doors 150 can be controlled independently.

In some implementations, a door 150 and an air vent 170 are positioned on a same panel. For example, as illustrated in FIGS. 3A and 3B, both the door 150 and the air vents 170 can be positioned on the front panel 208. In another example, both the door 150 and the air vents 170 can be positioned on the back panel 210.

In some implementations, as illustrated in FIG. 4, the door 150 includes air vents 170. Therefore, the door 150 can be used for ventilation in both open and closed positions. In some implementations, the door 150 includes an electromagnetic interference (EMI) shielding metal mesh. Therefore, the door 150 can be used for both ventilation and EMI shielding. For example, the door 150 can include an EMI shielding material (e.g., steel, aluminum, or copper) with mesh holes extending through the door 150. The mesh holes can have any suitable shape, e.g., honeycomb mesh or punched-hole mesh. The mesh holes can be distributed across the entire door surface. In some implementations, a size (e.g., an aperture) of a mesh hole is smaller than a wavelength of an EMI signal to be shielded against.

As illustrated in FIG. 3B, during a debugging process, the door 150 can be opened to allow the insertion of a troubleshooting cable 152 into the housing 106, establishing an electrical connection with an electronic device for troubleshooting. The troubleshooting cable 152 can be a joint test action group (JTAG) cable, a universal asynchronous receiver-transmitter (UART) cable, and/or a universal serial bus (USB) cable. During troubleshooting process, the troubleshooting cable 152 can send a command or signal to the corresponding electronic device of the computing device 100 to initiate diagnostics.

In some implementations, the computing device 100 includes a troubleshooting port 190 associated with a corresponding electronic device (e.g., processors 102). For example, the troubleshooting port 190 can be part of hardware interfaces that connect the corresponding electronic device (e.g., processors 102) to the troubleshooting cable 152. The troubleshooting port 190 can include JTAG port, UART port, USB debug port, PCIe debug slot, or any other suitable ports. When the troubleshooting cable 152 is connected to the corresponding electronic device through the troubleshooting port 190, the data can be transferred between the troubleshooting cable 152 and the electronic device for diagnosis.

During the troubleshooting process, the door 150 is in the open position 182. While it introduces more air into the housing 106, the overall impact on airflow may be reduced. Since both the door 150 and the air vent 170 may be located on the same panel, the extra ambient air can still flow from the same panel (e.g., the front panel 208) to the opposite panel (e.g., the back panel 210), thereby keeping the original airflow. In addition, as noted above, the door 150 can be positioned adjacent to a lower-temperature region of the computing device 100. Therefore, the thermal impact from the influx of ambient air can be reduced, as the temperature difference between the ambient air and the internal temperature in the lower-temperature region is smaller than that in the higher-temperature region. As a result, the internal temperature of the computing device 100 may remain substantially stable, similar to the temperature when the issue occurred or when the door 150 is opened. This contrasts with a situation where the top cover 202 is opened for tool insertion, which may have a significant impact on the airflow and the internal temperature within the housing 106. In addition, as the opened door 150 can provide an easy access to the internal electronic devices of the computing device 100, there may be no need to remove the computing device 100 from the rack, thereby further preserving the original environment for troubleshooting. Therefore, with the techniques in the present disclosure, the accuracy of diagnosis may be improved.

Additionally, or alternatively, the computing device 100 can be configured to, when it enters in a troubleshooting mode, maintain a stable internal temperature. In the troubleshooting mode, the door 150 can be opened, and the computing device 100 can be configured to receive the troubleshooting cable 152 for debugging. Returning to FIG. 1, in some implementations, the controller 120 is coupled to the door 150, the temperature sensor 108, and the cooler 110. In some implementations, the controller 120 is coupled to the door 150, the temperature sensor 108, and the cooler 110 through I2C interfaces. In some implementations, the door 150 is configured to transmit a request 130 to enter a troubleshooting mode for the computing device 100 when opened. For example, turning briefly to FIG. 3A, the door 150 can include a door sensor 156 configured to detect whether the door 150 is opened. In some examples, the door sensor 156 can include a magnet and a magnetometer. The magnet can be positioned near the hinge side of the door 150 (e.g., as illustrated in FIG. 3A) or the strike side of the door 150. The door sensor 156 can sense that the door 150 is opened and transmit an electrical signal (e.g., the request 130) to the controller 120. The electrical signal can indicate the request 130 to enter a troubleshooting mode.

In some implementations, the controller 120 is configured to receive, from the door 150, the request 130 to enter the troubleshooting mode. The controller 120 can be further configured to: in response to the request 130, obtain a first temperature from the temperature sensor 108; and set the first temperature as a target temperature for the troubleshooting mode. For example, in response to the request 130, the controller 120 can send a signal to the temperature sensor 108 to control the temperature sensor 108 to sense a present temperature (e.g., the first temperature). The temperature sensor 108 can then send the sensed first temperature to the controller 120. In another example, the controller 120 can periodically (e.g., every 30 s, 1 min, or 5 mins) obtain temperature readings from the temperature sensor 108 and store the temperature readings in a memory. In response to the request 130, the controller 120 can retrieve the most recent stored temperature reading (e.g., the first temperature) from the memory. After the first temperature is obtained, the controller 120 can be configured to set the first temperature as a target temperature for the troubleshooting mode. In other words, when the computing device 100 is in the troubleshooting mode, the target temperature at which the computing device 100 is configured to be maintained is the first temperature. The first temperature can reflect the temperature present when the issue occurred or when the door 150 is opened.

To maintain the computing device 100 at the first temperature, in some implementations, the controller 120 is configured to periodically (e.g., every 10 s, 30 s, 1 min, 2 mins, or 5 mins) obtain a second temperature from the temperature sensor 108; and transmitting a first control signal 132 to the cooler 110 based on the target temperature and the second temperature. For example, the second temperature can be the temperature readings obtained after the first temperature and may reflect real-time temperature levels inside the housing 106 during the troubleshooting process. Upon receiving each second temperature reading, the controller 120 can compare it against the target temperature and determine whether the second temperature matches with the target temperature. When the second temperature deviates from the target temperature by a threshold margin (e.g., by 5% or more, 10% or more, 20% or more, 30% or more, or 50% or more), the controller 120 can be configured to send the control signal to control the operations of the cooler 110.

In some implementations, the cooler 110 includes a fan, and the first control signal 132 controls the fan to: increase a fan speed of the fan when (e.g., in response to) the second temperature is higher than the target temperature; or decrease the fan speed when (e.g., in response to) the second temperature is equal to or lower than the target temperature. For example, the first control signal 132 can be an electrical voltage or a pulse-width modulation (PWM) signal. By modulating a voltage amplitude of the electrical voltage or a duty cycle of PWM signal, the controller 120 can encode a new fan speed into the first control signal 132. The fan can be configured to operate at the new fan speed based on the first control signal 132. In another example, the cooler 110 can include a cooler microcontroller, and the cooler microcontroller can be coupled to the controller 120. The first control signal 132 can be indicative of a difference value between the present temperature and the target temperature. The cooler microcontroller can be configured to, based on the first control signal 132, determine a new fan speed and control the fan to operate at the new fan speed. Increasing the fan speed can decrease the temperature inside the housing 106, while decreasing the fan speed can increase or maintain the temperature. By periodically monitoring the temperature inside the housing 106 and dynamically adjusting the fan speed, the computing device 100 can maintain the temperature at the target temperature (e.g., with a variation of 15% or less, 10% or less, 5% or less, or 3% or less). Therefore, the original environmental conditions (e.g., temperature) can be preserved during the troubleshooting process, thereby improving diagnosis accuracy.

In some implementations, the controller 120 is configured to: in response to the request 130, transmit a second control signal 134 to the electronic device, and the second control signal 134 instructs the electronic device to start logging diagnostic information for troubleshooting. The electronic device can be the device that is connected to the troubleshooting cable 152 when the computing device 100 is in the troubleshooting mode. As noted above, the electronic device can include a CPU, a GPU, a smart NIC, a PCH, a PCIe switch, a VR, or any other electronic device of the computing device 100. In the example implementation shown in FIG. 1, the electronic device includes a processor 102. When the processor 102 is connected to the troubleshooting cable 152, the controller 120 can transmit the second control signal 134 to the processor 102. Based on the second control signal 134, the processor 102 can start logging diagnostic information for troubleshooting. In some implementations, the diagnosis information includes error codes, crash dumps, status information (e.g., a temperature, a voltage level, a power level, a current level, or a utilization), and/or boot sequence logs. The diagnosis information can be generated in response to the signal from the troubleshooting cable 152, and/or based on a bult-in self-diagnosis module without any external triggering signals. By timely logging the diagnosis data, more information may be obtained for troubleshooting, which may improve the accuracy of fault diagnosis.

In some implementations, referring to FIGS. 1 and 3B, the computing device 100 includes two or more temperature sensors 108. For example, the computing device 100 can include a first temperature sensor (e.g., 108A of FIG. 3B), and a second temperature sensor (e.g., 108B of FIG. 3B). The first temperature sensor 108A can be positioned within or adjacent to a first electronic device (e.g., a processor 102), and a second temperature sensor 108B can be positioned within or adjacent to a second electronic device (e.g., a memory 103). Here, a temperature sensor 108 is considered positioned adjacent to an electronic device if a distance between the temperature sensor 108 and the electronic device is 10 cm or less, 5 cm or less, 3 cm or less, or 0.5 cm or less. The temperature sensor 108 can be configured to sense the temperature inside or near the corresponding electronic device. When an issue occurs, different electronic devices may experience different localized temperatures. Using different temperature sensors 108 can allow for better monitoring of temperature conditions at different locations within the computing device 100. For example, the first temperature sensor 108A can be configured to sense the temperature near the processor 102, while the second temperature can be configured to sense the temperature near the memory 103. As the processor 102 typically generates more heat than the memory 103, the first temperature sensor 108A may have a higher temperature reading than the second temperature sensor 108B.

In some implementations, the computing device 100 includes a first troubleshooting port 190A associated with the first electronic device (e.g., the processor 102), and a second troubleshooting port 190B associated with the second electronic device (e.g., the processor 102). In some implementations, the controller 120 is configured to: in response to the request 130, obtain a third temperature from the second temperature sensor 108B; and setting the third temperature as the target temperature for the troubleshooting mode when the second troubleshooting port 190B is connected to a troubleshooting cable 152. As noted above, different electronic devices can experience different localized temperature conditions based on the amount of heat they generate. Accordingly, different target temperatures can be set based on the localized temperature near different electronic devices. For example, when the processor 102 is connected to the troubleshooting cable 152 for diagnosis, a first temperature reading by a first temperature sensor 108A near the processor 102 can be set as a first target temperature. After the troubleshooting for the processor 102 is completed and the troubleshooting cable 152 is switched to the memory 103, a second temperature reading by a second temperature sensor 108B near the VR can be set as a new target temperature. By setting the target temperature to be the localized temperature near the target electronic device (e.g., the electronic device that is connected to the troubleshooting cable 152), the original environment conditions surrounding the target electronic device can be preserved, thereby further improve diagnosis accuracy.

A number of implementations have been described. Nevertheless, it will be understood that various modifications may be made without departing from the spirit and scope of the disclosure.

While the door 150 has been described as a side of the door still being attached to the housing 106 in the open position 182, in some implementations, the door 150 is configured to be completely detached from the housing 106 in the open position.

While the cooler 110 has been described as including a fan, the fan speed of which can be controlled by the controller 120, the cooler 110 can have any other suitable configuration. In some implementations, the cooler 110 includes a liquid cooler that has a pump and a fan. The control signal that is generated by the controller 120 can control or instruct the liquid cooler to increase or lower a fan speed or a pump speed to maintain the temperature at the target temperature.

In the implementations where the computing device 100 includes a plurality of temperature sensors, in response to the request 130 from the door 150, the controller 120 is configured to control each of the plurality of temperature sensors to sense a temperature. The controller can then select one of the temperature readings as a target temperature based on which electronic device is connected to the troubleshooting cable, as described above.

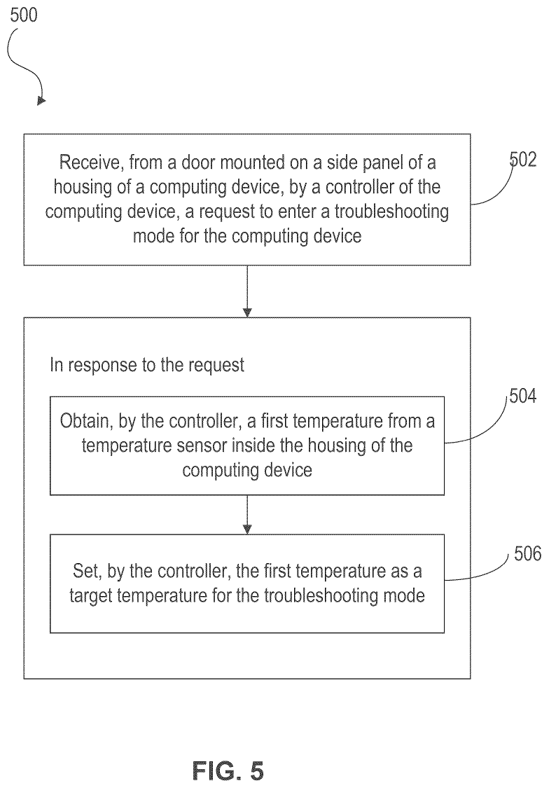

FIG. 5 illustrates a flow chart of an example of a method 500 of operating a computing device. The computing device can be the computing device 100 of FIGS. 1-2, 3A-3B, and 4.

At step 502, a request to enter a troubleshooting mode for the computing device can be received from a door mounted on a side panel of a housing of a computing device by a controller of the computing device. The request to enter a troubleshooting mode can be the request 130 of FIG. 1. The door can be, e.g., the door 150 of FIGS. 1, 3A-3B, and 4. The side panel can be, e.g., the front panel 208 of FIGS. 2, 3A-3B, and 4, the back panel 210 of FIGS. 2 and 3A-3B, the left panel 204 of FIG. 2, or the right panel 206 of FIG. 2. The housing can be, e.g., the housing 106 of FIGS. 1-2, 3A-3B, and 4. The controller can be, e.g., the controller 120 of FIG. 1.

In response to the request: at step 504, obtaining, by the controller, a first temperature from a temperature sensor inside the housing of the computing device; and at step 506, setting, by the controller, the first temperature as a target temperature for the troubleshooting mode, as described above in reference to FIGS. 1-2, 3A-3B, and 4. The temperature sensor can be, e.g., the temperature sensor 108 of FIGS. 1 and 3B.

In some implementations, the method 500 includes periodically obtaining a second temperature from the temperature sensor; and transmitting a first control signal to a cooler based on the target temperature and the second temperature. The first control signal can be, e.g., the first control signal 132 of FIG. 1. The cooler can be, e.g., the cooler 110 of FIG. 1.

In some implementations, the cooler includes a fan. The method includes increasing a running speed of the fan when the second temperature is higher than the target temperature; or decreasing the running speed when the second temperature is equal to or lower than the target temperature, as described above in reference to FIGS. 1-2, 3A-3B, and 4.

In some implementations, the method includes in response to the request, transmitting a second control signal to an electronic device; and in response to the second control signal, logging, by the electronic device, diagnostic information for troubleshooting. The second control signal can be, e.g., the second control signal 134 of FIG. 1. The electronic device can be, e.g., the processors 102 of FIG. 1, the power supply unit 105 of FIG. 1, memory 103 of FIG. 1, PCIe switch 104 of FIG. 1, or any other electronic devices described in the present disclosure.

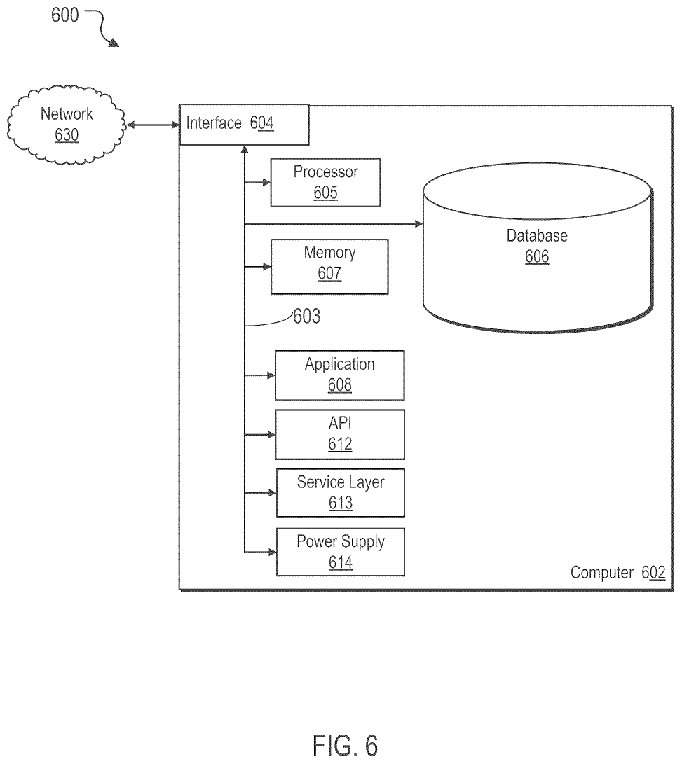

FIG. 6 is a block diagram illustrating an example of a computer-implemented System 600 used to provide computational functionalities associated with described algorithms, methods, functions, processes, flows, and procedures, according to an implementation of the present disclosure. In the illustrated implementation, computer-implemented system 600 includes a Computer 602 and a Network 630.

The illustrated Computer 602 is intended to encompass any computing device, such as a server, desktop computer, laptop/notebook computer, wireless data port, smart phone, personal data assistant (PDA), tablet computer, one or more processors within these devices, or a combination of computing devices, including physical or virtual instances of the computing device, or a combination of physical or virtual instances of the computing device. Additionally, the Computer 602 can include an input device, such as a keypad, keyboard, or touch screen, or a combination of input devices that can accept user information, and an output device that conveys information associated with the operation of the Computer 602, including digital data, visual, audio, another type of information, or a combination of types of information, on a graphical-type user interface (UI) (or GUI) or other UI.

The Computer 602 can serve in a role in a distributed computing system as, for example, a client, network component, a server, or a database or another persistency, or a combination of roles for performing the subject matter described in the present disclosure. The illustrated Computer 602 is communicably coupled with a Network 630. In some implementations, one or more components of the Computer 602 can be configured to operate within an environment, or a combination of environments, including cloud-computing, local, or global.

At a high level, the Computer 602 is an electronic computing device operable to receive, transmit, process, store, or manage data and information associated with the described subject matter. According to some implementations, the Computer 602 can also include or be communicably coupled with a server, such as an application server, e-mail server, web server, caching server, or streaming data server, or a combination of servers.

The Computer 602 can receive requests over Network 630 (for example, from a client software application executing on another Computer 602) and respond to the received requests by processing the received requests using a software application or a combination of software applications. In addition, requests can also be sent to the Computer 602 from internal users (for example, from a command console or by another internal access method), external or third-parties, or other entities, individuals, systems, or computers.

Each of the components of the Computer 602 can communicate using a System Bus 603. In some implementations, any or all of the components of the Computer 602, including hardware, software, or a combination of hardware and software, can interface over the System Bus 603 using an application programming interface (API) 612, a Service Layer 613, or a combination of the API 612 and Service Layer 613. The API 612 can include specifications for routines, data structures, and object classes. The API 612 can be either computer-language independent or dependent and refer to a complete interface, a single function, or even a set of APIs. The Service Layer 613 provides software services to the Computer 602 or other components (whether illustrated or not) that are communicably coupled to the Computer 602. The functionality of the Computer 602 can be accessible for all service consumers using the Service Layer 613. Software services, such as those provided by the Service Layer 613, provide reusable, defined functionalities through a defined interface. For example, the interface can be software written in a computing language (for example JAVA or C++) or a combination of computing languages, and providing data in a particular format (for example, extensible markup language (XML)) or a combination of formats. While illustrated as an integrated component of the Computer 602, alternative implementations can illustrate the API 612 or the Service Layer 613 as stand-alone components in relation to other components of the Computer 602 or other components (whether illustrated or not) that are communicably coupled to the Computer 602. Moreover, any or all parts of the API 612 or the Service Layer 613 can be implemented as a child or a sub-module of another software module, enterprise application, or hardware module without departing from the scope of the present disclosure.

The Computer 602 includes an Interface 604. Although illustrated as a single Interface 604, two or more Interfaces 604 can be used according to particular needs, desires, or particular implementations of the Computer 602. The Interface 604 is used by the Computer 602 for communicating with another computing system (whether illustrated or not) that is communicatively linked to the Network 630 in a distributed environment. Generally, the Interface 604 is operable to communicate with the Network 630 and includes logic encoded in software, hardware, or a combination of software and hardware. More specifically, the Interface 604 can include software supporting one or more communication protocols associated with communications such that the Network 630 or hardware of Interface 604 is operable to communicate physical signals within and outside of the illustrated Computer 602.

The Computer 602 includes a Processor 605. Although illustrated as a single Processor 605, two or more Processors 605 can be used according to particular needs, desires, or particular implementations of the Computer 602. Generally, the Processor 605 executes instructions and manipulates data to perform the operations of the Computer 602 and any algorithms, methods, functions, processes, flows, and procedures as described in the present disclosure.

The Computer 602 also includes a Database 606 that can hold data for the Computer 602, another component communicatively linked to the Network 630 (whether illustrated or not), or a combination of the Computer 602 and another component. For example, Database 606 can be an in-memory or conventional database storing data consistent with the present disclosure. In some implementations, Database 606 can be a combination of two or more different database types (for example, a hybrid in-memory and conventional database) according to particular needs, desires, or particular implementations of the Computer 602 and the described functionality. Although illustrated as a single Database 606, two or more databases of similar or differing types can be used according to particular needs, desires, or particular implementations of the Computer 602 and the described functionality. While Database 606 is illustrated as an integral component of the Computer 602, in alternative implementations, Database 606 can be external to the Computer 602. The Database 606 can hold and operate on at least any data type mentioned or any data type consistent with this disclosure.

The Computer 602 also includes a Memory 607 that can hold data for the Computer 602, another component or components communicatively linked to the Network 630 (whether illustrated or not), or a combination of the Computer 602 and another component. Memory 607 can store any data consistent with the present disclosure. In some implementations, Memory 607 can be a combination of two or more different types of memory (for example, a combination of semiconductor and magnetic storage) according to particular needs, desires, or particular implementations of the Computer 602 and the described functionality. Although illustrated as a single Memory 607, two or more Memories 607 or similar or differing types can be used according to particular needs, desires, or particular implementations of the Computer 602 and the described functionality. While Memory 607 is illustrated as an integral component of the Computer 602, in alternative implementations, Memory 607 can be external to the Computer 602.

The Application 608 is an algorithmic software engine providing functionality according to particular needs, desires, or particular implementations of the Computer 602, particularly with respect to functionality described in the present disclosure. For example, Application 608 can serve as one or more components, modules, or applications. Further, although illustrated as a single Application 608, the Application 608 can be implemented as multiple Applications 608 on the Computer 602. In addition, although illustrated as integral to the Computer 602, in alternative implementations, the Application 608 can be external to the Computer 602.

The Computer 602 can also include a Power Supply 614. The Power Supply 614 can include a rechargeable or non-rechargeable battery that can be configured to be either user- or non-user-replaceable. In some implementations, the Power Supply 614 can include power-conversion or management circuits (including recharging, standby, or another power management functionality). In some implementations, the Power Supply 614 can include a power plug to allow the Computer 602 to be plugged into a wall socket or another power source to, for example, power the Computer 602 or recharge a rechargeable battery.

There can be any number of Computers 602 associated with, or external to, a computer system containing Computer 602, each Computer 602 communicating over Network 630. Further, the term “client,” “user,” or other appropriate terminology can be used interchangeably, as appropriate, without departing from the scope of the present disclosure. Moreover, the present disclosure contemplates that many users can use one Computer 602, or that one user can use multiple computers 602.

Described implementations of the subject matter can include one or more features, alone or in combination.

For example, in a first implementation, a computing device includes: a housing; a cooler; a temperature sensor inside the housing; a door moveably mounted on a side panel of the housing, wherein the door is configured to transmit a request to enter a troubleshooting mode for the computing device in response to the door being opened; a controller coupled to the door, the temperature sensor, and the cooler, wherein the controller is configured to: receive, from the door, the request to enter the troubleshooting mode; and in response to the request: obtain a first temperature from the temperature sensor; and set the first temperature as a target temperature for the troubleshooting mode.

The foregoing and other described implementations can each, optionally, include one or more of the following features:

A first feature, combinable with any of the following features, wherein the door is configured to cover an opening on the side panel of the housing in response to the door being closed, and wherein the opening allows a troubleshooting cable to be inserted into the housing.

A second feature, combinable with any of the previous or following features, wherein the controller is configured to: periodically obtain a second temperature from the temperature sensor; and transmit a first control signal to the cooler based on the target temperature and the second temperature.

A third feature, combinable with any of the previous or following features, wherein: the cooler comprises a fan; and the first control signal controls the fan to: increase a running speed of the fan in response to the second temperature being higher than the target temperature; or decrease the running speed in response to the second temperature being equal to or lower than the target temperature.

A fourth feature, combinable with any of the previous or following features, wherein the computing device comprises an electronic device, the temperature sensor is within or adjacent to the electronic device, and the electronic device comprises at least one of a central processing unit (CPU), a graphical processing unit (GPU), a smart network interface card (NIC), a platform controller hub (PCH), or a voltage regulator (VR).

A fifth feature, combinable with any of the previous or following features, wherein the controller is configured to: in response to the request, transmit a second control signal to the electronic device, wherein the second control signal instructs the electronic device to start logging diagnostic information for troubleshooting.

A sixth feature, combinable with any of the previous or following features, wherein: the temperature sensor is a first temperature sensor. The computing device comprises a second temperature sensor, a first electronic device, a second electronic device, a first troubleshooting port associated with the first electronic device, and a second troubleshooting port associated with the second electronic device; the first temperature sensor is within or adjacent to the first electronic device; the second temperature sensor is within or adjacent to the second electronic device; and the controller is configured to: obtain a third temperature from the second temperature sensor; and set the third temperature as the target temperature for the troubleshooting mode in response to the second troubleshooting port being connected to a troubleshooting cable.

A seventh feature, combinable with any of the previous or following features, wherein the door comprises an electromagnetic interference (EMI) shielding metal mesh.

An eighth feature, combinable with any of the previous or following features, wherein the controller is a baseboard management controller (BMC), and wherein the BMC is coupled to the door, the temperature sensor, and the cooler through inter-integrated circuit (I2C) interfaces.

A ninth feature, combinable with any of the previous or following features, wherein the computing device includes an air vent on the side panel of the housing.

A tenth feature, combinable with any of the previous or following features, wherein the door comprises an air vent.

In a second implementation, a computer-implemented method includes: receiving, from a door mounted on a side panel of a housing of a computing device, by a controller of the computing device, a request to enter a troubleshooting mode for the computing device; and in response to the request: obtaining, by the controller, a first temperature from a temperature sensor inside the housing of the computing device; and setting, by the controller, the first temperature as a target temperature for the troubleshooting mode.

The foregoing and other described implementations can each, optionally, include one or more of the following features:

A first feature, combinable with any of the following features, the method includes periodically obtaining a second temperature from the temperature sensor; and transmitting a first control signal to a cooler based on the target temperature and the second temperature.

A second feature, combinable with any of the previous or following features, wherein: the cooler comprises a fan; and the method comprises: increasing a running speed of the fan in response to the second temperature being higher than the target temperature; or decreasing the running speed in response to the second temperature being equal to or lower than the target temperature.

A third feature, combinable with any of the previous or following features, wherein the method includes in response to the request, transmitting a second control signal to an electronic device; and in response to the second control signal, logging, by the electronic device, diagnostic information for troubleshooting.

A fourth feature, combinable with any of the previous or following features, wherein the door comprises an electromagnetic interference (EMI) shielding metal mesh.

In a third implementation, a non-transitory computer-readable medium storing program instructions to perform operations includes: receiving, from a door mounted on a side panel of a housing of a computing device, by a controller of the computing device, a request to enter a troubleshooting mode for the computing device; and in response to the request: obtaining, by the controller, a first temperature from a temperature sensor inside the housing of the computing device; and setting, by the controller, the first temperature as a target temperature for the troubleshooting mode.

The foregoing and other described implementations can each, optionally, include one or more of the following features:

A first feature, combinable with any of the following features, wherein the operations comprise: periodically obtaining a second temperature from the temperature sensor; and transmitting a first control signal to a cooler based on the target temperature and the second temperature.

A second feature, combinable with any of the previous or following features, wherein: the cooler comprises a fan; and the operations comprise: increasing a running speed of the fan in response to the second temperature being higher than the target temperature; or decreasing the running speed in response to the second temperature being equal to or lower than the target temperature.

A third feature, combinable with any of the previous or following features, wherein the operations comprise: in response to the request, transmitting a second control signal to an electronic device; and in response to the second control signal, logging, by the electronic device, diagnostic information for troubleshooting.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable medium for execution by, or to control the operation of, a computer or computer-implemented system. Alternatively, or additionally, the program instructions can be encoded in/on an artificially generated propagated signal, for example, a machine-generated electrical, optical, or electromagnetic signal that is generated to encode information for transmission to a receiver apparatus for execution by a computer or computer-implemented system. The computer-storage medium can be a machine-readable storage device, a machine-readable storage substrate, a random or serial access memory device, or a combination of computer-storage mediums. Configuring one or more computers means that the one or more computers have installed hardware, firmware, or software (or combinations of hardware, firmware, and software) so that when the software is executed by the one or more computers, particular computing operations are performed. The computer storage medium is not, however, a propagated signal.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the request 130ed data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” “computing device 100,” or “electronic computer device” (or an equivalent term as understood by one of ordinary skill in the art) refer to data processing hardware and encompass all kinds of apparatuses, devices, and machines for processing data, including by way of example, a programmable processor, a computer, or multiple processors or computers. The computer can also be, or further include special-purpose logic circuitry, for example, a central processing unit (CPU), a field-programmable gate array (FPGA), or an application-specific integrated circuit (ASIC). In some implementations, the computer or computer-implemented system or special-purpose logic circuitry (or a combination of the computer or computer-implemented system and special-purpose logic circuitry) can be hardware- or software-based (or a combination of both hardware- and software-based). The computer can optionally include code that creates an execution environment for computer programs, for example, code that constitutes processor firmware, a protocol stack, a database management system, an operating system, or a combination of execution environments. The present disclosure contemplates the use of a computer or computer-implemented system with an operating system, for example LINUX, UNIX, WINDOWS, MAC OS, ANDROID, or IOS, or a combination of operating systems.

The term “and/or” can refer to and encompasses any and all possible combinations of one or more of the associated listed terms. For example, the term “A and/or B” means that either option A, option B, or both options A and B are possible, where A and B may be singular or plural.

A computer program, which can also be referred to or described as a program, software, a software application, a unit, a module, a software module, a script, code, or other electronic device can be written in any form of programming language, including compiled or interpreted languages, or declarative or procedural languages, and it can be deployed in any form, including, for example, as a stand-alone program, module, electronic device, or subroutine, for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network.

While portions of the programs illustrated in the various figures can be illustrated as individual electronic devices, such as units or modules, that implement described features and functionality using various objects, methods, or other processes, the programs can instead include a number of sub-units, sub-modules, third-party services, electronic devices, libraries, and other electronic devices, as appropriate. Conversely, the features and functionality of various electronic devices can be combined into single electronic devices, as appropriate. Thresholds used to make computational determinations can be statically, dynamically, or both statically and dynamically determined.

Described methods, processes, or logic flows represent one or more examples of functionality consistent with the present disclosure and are not intended to limit the disclosure to the described or illustrated implementations, but to be accorded the widest scope consistent with described principles and features. The described methods, processes, or logic flows can be performed by one or more programmable computers executing one or more computer programs to perform functions by operating on input data and generating output data. The methods, processes, or logic flows can also be performed by, and computers can also be implemented as, special-purpose logic circuitry, for example, a CPU, an FPGA, or an ASIC.

Computers for the execution of a computer program can be based on general or special-purpose microprocessors, both, or another type of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable memory storage device, for example, a universal serial bus (USB) flash drive, to name just a few.

Non-transitory computer-readable media for storing computer program instructions and data can include all forms of permanent/non-permanent or volatile/non-volatile memory, media and memory devices, including by way of example semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices; magnetic devices, for example, tape, cartridges, cassettes, internal/removable disks; magneto-optical disks; and optical memory devices, for example, digital versatile/video disc (DVD), compact disc (CD)-ROM, DVD+/−R, DVD-RAM, DVD-ROM, high-definition/density (HD)-DVD, and BLU-RAY/BLU-RAY DISC (BD), and other optical memory technologies. The memory can store various objects or data, including caches, classes, frameworks, applications, modules, backup data, jobs, web pages, web page templates, data structures, database tables, repositories storing dynamic information, or other appropriate information including any parameters, variables, algorithms, instructions, rules, constraints, or references. Additionally, the memory can include other appropriate data, such as logs, policies, security or access data, or reporting files. The processor and the memory can be supplemented by, or incorporated in, special-purpose logic circuitry.

To provide for interaction with a user, implementations of the subject matter described in this specification can be implemented on a computer having a display device, for example, a cathode ray tube (CRT), liquid crystal display (LCD), light emitting diode (LED), or plasma monitor, for displaying information to the user and a keyboard and a pointing device, for example, a mouse, trackball, or trackpad by which the user can provide input to the computer. Input can also be provided to the computer using a touchscreen, such as a tablet computer surface with pressure sensitivity or a multi-touch screen using capacitive or electric sensing. Other types of devices can be used to interact with the user. For example, feedback provided to the user can be any form of sensory feedback (such as, visual, auditory, tactile, or a combination of feedback types). Input from the user can be received in any form, including acoustic, speech, or tactile input. In addition, a computer can interact with the user by sending documents to and receiving documents from a client computing device 100 that is used by the user (for example, by sending web pages to a web browser on a user's mobile computing device 100 in response to request 130s received from the web browser).

The term “graphical user interface (GUI)” can be used in the singular or the plural to describe one or more graphical user interfaces and each of the displays of a particular graphical user interface. Therefore, a GUI can represent any graphical user interface, including but not limited to, a web browser, a touch screen, or a command line interface (CLI) that processes information and efficiently presents the information results to the user. In general, a GUI can include a number of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end electronic device, for example, as a data server, or that includes a middleware electronic device, for example, an application server, or that includes a front-end electronic device, for example, a client computer having a graphical user interface or a Web browser through which a user can interact with an implementation of the subject matter described in this specification, or any combination of one or more such back-end, middleware, or front-end electronic devices. The electronic devices of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11x or other protocols, all or a portion of the Internet, another communication network, or a combination of communication networks. The communication network can communicate with, for example, internet Protocol (IP) packets, frame relay frames, Asynchronous Transfer Mode (ATM) cells, voice, video, data, or other information between network nodes.

The computing system can include clients and servers. A client and server are generally remote from each other and typically interact through a communication network. The relationship of client and server arises by virtue of computer programs running on the respective computers and having a client-server relationship to each other.

As used herein, the term “at least one of” can refer to and encompass any and all possible combinations of one or more of the associated listed terms. For example, the term “at least one of A, B, or C” means that (i) at least one of A, (ii) at least one of B, (iii) at least one of C, (iv) at least one of A and at least one of B, (v) at least one of B and at least one of C, (vi) at least one of A and at least one of C, or (vi) at least one of A, at least one of B and at least one of C are possible, where A, B and C may be singular or plural.

While this specification contains many specific implementation details, these should not be construed as limitations on the scope of any inventive concept or on the scope of what can be claimed, but rather as descriptions of features that can be specific to particular implementations of particular inventive concepts. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

The separation or integration of various system modules and electronic devices in the previously described implementations should not be understood as requiring such separation or integration in all implementations, and it should be understood that the described program electronic devices and systems can generally be integrated together in a single software product or packaged into multiple software products.

Accordingly, the previously described example implementations do not define or constrain the present disclosure. Other changes, substitutions, and alterations are also possible without departing from the scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A computing device, comprising:
a housing;
a cooler;
a temperature sensor inside the housing;
a door moveably mounted on a side panel of the housing, wherein the door is configured to transmit a request to enter a troubleshooting mode for the computing device in response to the door being opened; and
a controller coupled to the door, the temperature sensor, and the cooler, wherein the controller is configured to:
receive, from the door, the request to enter the troubleshooting mode; and
in response to the request:
obtain a first temperature from the temperature sensor; and
set the first temperature as a target temperature for the troubleshooting mode.

2. The computing device of claim 1, wherein the door is configured to cover an opening on the side panel of the housing in response to the door being closed, and wherein the opening allows a troubleshooting cable to be inserted into the housing.

3. The computing device of claim 1, wherein the controller is configured to:
periodically obtain a second temperature from the temperature sensor; and
transmit a first control signal to the cooler based on the target temperature and the second temperature.

4. The computing device of claim 3, wherein:
the cooler comprises a fan; and
the first control signal controls the fan to:
increase a running speed of the fan in response to the second temperature being higher than the target temperature; or
decrease the running speed in response to the second temperature being equal to or lower than the target temperature.

5. The computing device of claim 1, wherein the computing device comprises an electronic device, the temperature sensor is within or adjacent to the electronic device, and the electronic device comprises at least one of a central processing unit (CPU), a graphical processing unit (GPU), a smart network interface card (NIC), a platform controller hub (PCH), or a voltage regulator (VR).

6. The computing device of claim 5, wherein the controller is configured to:
in response to the request, transmit a second control signal to the electronic device, wherein the second control signal instructs the electronic device to start logging diagnostic information for troubleshooting.

7. The computing device of claim 1, wherein:
the temperature sensor is a first temperature sensor;
the computing device comprises a second temperature sensor, a first electronic device, a second electronic device, a first troubleshooting port associated with the first electronic device, and a second troubleshooting port associated with the second electronic device;
the first temperature sensor is within or adjacent to the first electronic device;
the second temperature sensor is within or adjacent to the second electronic device; and
the controller is configured to:
obtain a third temperature from the second temperature sensor; and
set the third temperature as the target temperature for the troubleshooting mode in response to the second troubleshooting port being connected to a troubleshooting cable.

8. The computing device of claim 1, wherein the door comprises an electromagnetic interference (EMI) shielding metal mesh.

9. The computing device of claim 1, wherein the controller is a baseboard management controller (BMC), and wherein the BMC is coupled to the door, the temperature sensor, and the cooler through inter-integrated circuit (I2C) interfaces.

10. The computing device of claim 1, comprising:
an air vent on the side panel of the housing.

11. The computing device of claim 1, wherein the door comprises an air vent.

12. A computer-implemented method, comprising:
receiving, from a door mounted on a side panel of a housing of a computing device, by a controller of the computing device, a request to enter a troubleshooting mode for the computing device; and
in response to the request:
obtaining, by the controller, a first temperature from a temperature sensor inside the housing of the computing device; and
setting, by the controller, the first temperature as a target temperature for the troubleshooting mode.

13. The method of claim 12, comprising:
periodically obtaining a second temperature from the temperature sensor; and
transmitting a first control signal to a cooler based on the target temperature and the second temperature.

14. The method of claim 13, wherein:
the cooler comprises a fan; and
the method comprises:
increasing a running speed of the fan in response to the second temperature being higher than the target temperature; or
decreasing the running speed in response to the second temperature being equal to or lower than the target temperature.

15. The method of claim 12, comprising:
in response to the request, transmitting a second control signal to an electronic device; and
in response to the second control signal, logging, by the electronic device, diagnostic information for troubleshooting.

16. The method of claim 12, wherein the door comprises an electromagnetic interference (EMI) shielding metal mesh.

17. A non-transitory computer-readable medium storing program instructions to perform operations comprising:
receiving, from a door mounted on a side panel of a housing of a computing device, by a controller of the computing device, a request to enter a troubleshooting mode for the computing device; and
in response to the request:
obtaining, by the controller, a first temperature from a temperature sensor inside the housing of the computing device; and
setting, by the controller, the first temperature as a target temperature for the troubleshooting mode.

18. The non-transitory computer-readable medium of claim 17, wherein the operations comprise:
periodically obtaining a second temperature from the temperature sensor; and
transmitting a first control signal to a cooler based on the target temperature and the second temperature.

19. The non-transitory computer-readable medium of claim 18, wherein:
the cooler comprises a fan; and
the operations comprise:
increasing a running speed of the fan in response to the second temperature being higher than the target temperature; or
decreasing the running speed in response to the second temperature being equal to or lower than the target temperature.

20. The non-transitory computer-readable medium of claim 17, wherein the operations comprise:
in response to the request, transmitting a second control signal to an electronic device; and
in response to the second control signal, logging, by the electronic device, diagnostic information for troubleshooting.
